(19) United States
(12) Patent Application Publication
(10) Pub. No.: US 2008/0040421 A1
(43) Pub. Date: Feb. 14, 2008

(54) SYSTEMS AND METHODS FOR INTEGRATING A PATIENT KIOSK WITH A HEALTHCARE INFORMATION SYSTEM

(75) Inventor: Michael John VanKoevering, South Burlington, VT (US)

Correspondence Address: MCANDREWS HELD & MALLOY, LTD, 500 WEST MADISON STREET, SUITE 3400, CHICAGO, IL, 60661, US

(73) Assignee: General Electric Company, Schenectady, NY (US)

(21) Appl. No.: 11/619,501

(22) Filed: Jan. 3, 2007

Related U.S. Application Data
(60) Provisional application No. 60/822,205, filed on Aug. 11, 2006.

(51) Int. Cl. G06F 15/16

(52) U.S. Cl. 709/203

(57) ABSTRACT

Certain embodiments provide systems and methods for integrating a patient kiosk and a healthcare information system. Certain embodiments provide a method including generating a query for at least one of information and a service; forming a message including the query using a Web service; communicating the message between the kiosk system and the healthcare information system using the Web service; and returning a result based on the message. Certain embodiments provide an integrated kiosk and healthcare information system including a kiosk configured to provide at least one of information and services and configured to accept entry of patient information; a healthcare information system including patient information, practice information and services; and a Web service configured to facilitate communication of data between the kiosk and the healthcare information system via a network. Data is communicated between the kiosk and the healthcare information system based on a direct query.

### RELATED APPLICATION

This application claims priority to a provisional application entitled “Systems and Methods for Integrating a Patient Kiosk with a Healthcare Information System,” filed on Aug. 11, 2006, as Ser. No. 60/822,205, which is herein incorporated by reference in its entirety.

### BACKGROUND OF THE INVENTION

The present invention generally relates to patient management and information systems. More specifically, the present invention relates to integration of a patient kiosk with patient management and information system.

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure. Additionally, patients may access information systems for scheduling, diagnosis and/or treatment information, check-in or admission, and/or other tasks. One or more of these systems comprise a healthcare information system, for example.

Kiosks and other workstations allow a patient to check-in to a hospital or clinic instead of going to a front-desk staff member employed by the hospital or clinic. Prior solutions to automate check-in have used Health Level Seven (HL7) interfaces and a third party interface engine to keep the kiosk and hospital or clinic information system updated. Interface transmissions conform to the limitations of HL7 record definitions to pass information between the kiosk and the information system. Additionally, communications between the kiosk and the healthcare information system have not occurred in real-time. Requests from the kiosk suffered from a lag inherent in the interface engine when processing the kiosk requests. Furthermore, if the interface engine were down or otherwise unavailable, then the kiosk would not work.

Thus, there is a need for systems and methods for improved interaction between a kiosk and a healthcare information system. There is a need for alternatives to providing an interface between a kiosk and a separate information system.

### BRIEF SUMMARY OF THE INVENTION

Certain embodiments of the present invention provide systems and methods for integrating a patient kiosk and a healthcare information system.

Certain embodiments provide a method including generating a query for at least one of information and a service; forming a message including the query using a Web service; communicating the message between the kiosk system and the healthcare information system using the Web service; and returning a result based on the message.

Certain embodiments provide an integrated kiosk and healthcare information system including a kiosk configured to provide at least one of information and services and configured to accept entry of patient information; a healthcare information system including patient information, practice information and services; and a Web service configured to facilitate communication of data between the kiosk and the healthcare information system via a network. Data is communicated between the kiosk and the healthcare information system on the network based on a direct query.

Certain embodiments provide an integration system for integrating interaction between a kiosk and a healthcare information system. The integration system includes a Web service configured to facilitate communication of data and commands between a kiosk and a healthcare information system via a network. Data and commands are communicated between the kiosk and the healthcare information system on the network based on a direct-access query. The integration system may also include a translation layer configured to convert an output of the healthcare information system to an input for the kiosk and convert an output of the kiosk to an input for the healthcare information system.

### BRIEF DESCRIPTION OF SEVERAL VIEWS OF THE DRAWINGS

FIG. 1 illustrates a healthcare information system used in accordance with an embodiment of the present invention.

FIG. 2 illustrates a flow diagram for a method for integrating a kiosk with a healthcare information system in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide for systems and methods for providing medical practice and patient management.

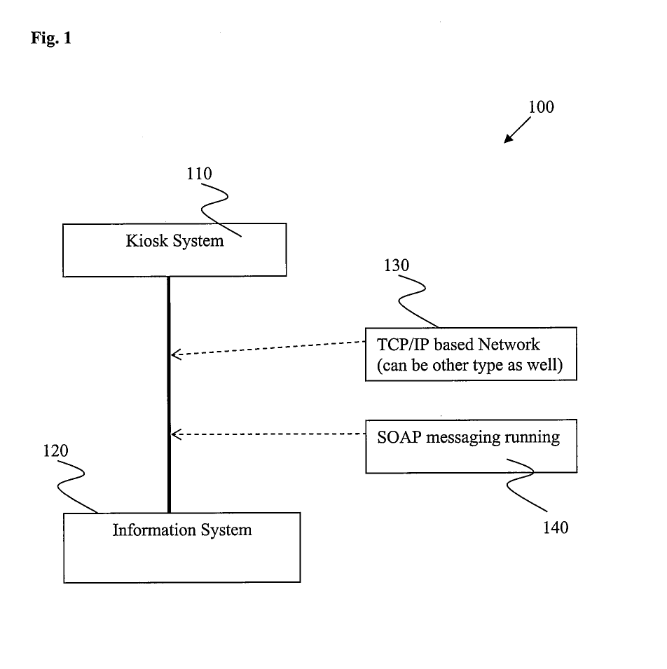

FIG. 1 illustrates a healthcare information system healthcare administrative and financial system 100 used in accordance with an embodiment of the present invention. The system 100 includes a kiosk system 110, an information system 120, a TCP/IP (Transmission Control Protocol/Internet Protocol) based network 130 and SOAP messaging 140. In certain embodiments, the system 100 may include other components, such as additional kiosks, additional systems (e.g., additional healthcare or clinical information systems), additional networks, etc.

The components and/or functionality of system 100 may be implemented alone or in combination in hardware, firmware, and/or as a set of instructions in software, for example. Certain embodiments may be provided as a set of instructions residing on a computer-readable medium, such as a memory, CD, DVD, or hard disk, for execution on a computer or other processing device.

The kiosk system 110 may include a self-service user kiosk, such as a kiosk from Galvanon, DynaTouch, Vecna, Friendlyway, OTech, etc. The kiosk system 110 may be implemented as a freestanding station, a computer terminal or workstation, a wireless handheld device, a Web-based or Internet-driven application and/or software on another computing device, for example.

The kiosk system 110 may allow patients to check-in or be admitted to a healthcare facility electronically without necessarily interacting with a nurse or clerk. For example, patients may be checked in for hospital stays, lab visits, and/or physician office appointments by swiping, scanning or otherwise entering a membership card, credit card, or driver's license at the kiosk system 110. Alternatively and/or in addition, patient identification may be facilitated using thumbprint or other biometric identification and/or electronic signature, for example. Information may also be entered using a keyboard, keypad, touchscreen, etc.

Consent and HIPAA (“Health Insurance Portability and Accountability Act”) forms, for example, may be completed electronically by a patient via the kiosk system 110. Additional information, such as demographic information, medical history information and medical complaint/symptom information, may be entered electronically. Thus, for example, information may be recorded with improved accuracy and patient check-in may be streamlined. Patient co-pay and/or other billing may also be facilitated via the kiosk system 110. A credit card, debit card, check and/or cash may be used to pay at the kiosk system 110. Additionally, a patient may view and pay outstanding balances via the kiosk system 110. Furthermore, the kiosk system 110 may be used to provide information regarding directions, maps and/or other information to a patient.

The kiosk system 110 integrates with a healthcare information system, such as the information system 120, for patient check-in, information transfer/storage and/or provision of other services, for example.

The system 120 may include a healthcare information system, such as the GE/IDX Flowcast® system. The system 120 may include information and/or functionality including administrative, financial, patient management, practice management, medical records, etc. The system 120 provides capabilities to improve revenue cycle management and data integrity, for example. Clinical and billing information may be input and shared across a clinical enterprise. Regulatory compliance is also improved through data maintenance and sharing. The system 120 may implement a “best practices” workflow to help ensure improved data capture from patients, clinicians and other users. Predetermined workflows may be provided via the system 120 to streamline patient, clinician and other employee activity. Work flow information may be sent between the system 120 and the kiosk 110 to control how the kiosk 110 responds to a certain situation or set of situations, for example. Claim and eligibility data may be entered and automatically verified to reduce claim denial. Additionally, the system 120 provides improved and simplified access to and management of patient data by clinicians and other employees. The system 120 may provide electronic medical records support to capture and access patient medical data. In certain embodiments, the system 120 may include one or more subsystems and/or applications including an order entry system, a results review system, a patient information system, a clinical decision support system, a configuration management system, a medication management system, a clinical information viewer, an allergy/problems database, a printing/reporting module, security, patient privacy protection, clinical scheduling, personal calendar, electronic mail, electronic messaging or “chat”, and/or medical resources, for example.

In certain embodiments, the system 120 may be used to facilitate access management through functional features such as a master patient index, enterprise-wide scheduling, patient visit management, eligibility verification, referrals and authorization, online tools for patients and referring physicians, and advance beneficiary notice and ambulatory payment classifications. For example, visit information is shared between hospital and physician environments, to help ensure accurate and complete information across the entire revenue cycle. Flexible admission/discharge/transfer (ADT) functions and an online bed board may help to enable proactive capacity control and bed management.

In certain embodiments, the system 120 may provide several financial capabilities to clinicians, other employees and patient. Organizations can leverage the benefits of the administrative and financial system 120 in one setting and/or across the enterprise. Built-in payer rules may help to ensure that patient information is collected correctly and completely before care is provided. Automatic charge capture cuts costs by reducing staff needed to process data manually. Additionally, claims rejections, re-work and lost charges may be reduced, maximizing reimbursement. Electronic claims, claims status checks and remittances drive more efficient overall processing and decrease time to payment. Charges may be automatically checked for accuracy prior to submission for cleaner claims, fewer rejections and less effort to correct and re-bill denials. Workflow tools may be provided to automate and streamline claims management and production to accelerate reimbursement and maximize staff productivity. Simplified, patient-friendly statements may help to reduce patient calls and improve patient satisfaction.

In certain embodiments, the system 120 and kiosk 110 help enable organizations to establish a combined business office to tie together multiple hospitals or clinics and/or link physician and hospital settings to help improve efficiency, enhance patient satisfaction and increase cash flow enterprise-wide. The system 120 may streamline workflow, for example, by presenting a consolidated view of all clinical and professional financial data for a patient, guarantor or clinical encounter. Charges may be combined for both hospital/clinic and professional services on a single statement, for example.

The system 120 may also provide flexible, interactive reporting and analysis capabilities for clinicians and patients. For example, data may be stored in a relational database for querying and reporting. Analytical processing tools may be provided to review information from multiple points of view.

Additionally, certain embodiments of the system 120 may provide automated task management, electronic work lists and built-in intelligence to help eliminate unnecessary manual tasks. System alerts and reminders may be used to notify staff of outstanding tasks and automatically prioritize critical issues. In certain embodiments, documents may be captured across multiple business processes and integrated directly into the workflow.

In certain embodiments, the system 100 provides an integrated solution for communication between the kiosk system 110 and the healthcare information system 120. The kiosk vendor has an integrated method and system to communicate with the healthcare information system 120. One or more Web services are defined to execute over a TCP/IP network 130 using the Simple Object Access Protocol (SOAP). The system 100 may include one or more Web services and one or more methods for a Web service, for example. The web service(s) provide the kiosk system 110 with an ability to query the information system 120 for a list of patients, for example, based on search criteria that the patient provides at the kiosk 110. The web service(s) may return information such as registration, insurance, appointment, visit and/or financial information that may then be used by the kiosk system 110 to check in or admit the patient. The service(s) also provide for an ability to instruct the kiosk system 110 to return updated registration, insurance, appointment, visit and/or financial data, for example, back to the administrative and financial system 120 for continued processing in a system workflow.

A Web service is a software system designed to support interoperable machine-to-machine interaction over a network, such as TCP/IP network 130. Other systems, such as the kiosk system 110, interact with the Web service using messages enclosed in a wrapper, such as a SOAP message 140. SOAP messages include Extensible Markup Language (XML) and/or Binary XML content, for example, and/or other Web-related language or standard-based content. The kiosk system 110 and the system 120 use Web services to exchange data over a network 130 in a manner similar to inter-process communication on a single computer. Thus, the kiosk system 110 and the administrative and financial system 120 are integrated rather than simply interfaced. The kiosk system 110 and the system 120 become interoperable and exchange data via Web service(s). The Web service(s) rely on industry standard format(s) and protocol(s) (such as SOAP with XML), for example, to facilitate the exchange of data.

Use of Web services allows units of functionality to be shared according to an industry standard. The use of Web services allows the communicating systems to be loosely coupled yet still integrated. Using Web Services, either system's implementation may change without affecting the other system as long as the interface between the two systems remains consistent.

SOAP is a protocol for exchanging XML-based messages over a computer network, such as TCP/IP network 130, using Hypertext Transfer Protocol (HTTP) and/or Simple Mail Transfer Protocol (SMTP), for example. SOAP forms a foundation layer of a Web services stack and provides a basic messaging framework upon which additional layers may build. SOAP may be used for messaging in a variety of patterns. For example, a remote procedure call (RPC) may used to allow one network node (known as a client, such as the kiosk system 110) to send a request message to another network node (known as a server, such as the system 120), and the second network node sends a response message to the first network node.

Because the systems 110 and 120 are integrated using Web services and the SOAP protocol to provide the integration, the systems 110 and 120 are not relying on a third system to interface information between systems 110 and 120. In addition, the kiosk system 110 is able to call or communicate directly into the information system 120 so that transactions may be performed in real-time or substantially real-time (i.e., some inherent hardware and/or software delay may still exist). Furthermore, information shared between the systems 110 and 120 is not limited to what HL7 record definitions provide. Therefore, transactions may be tailored to a specific task, rather than relying on a format (such as HL7) that may not be designed to handle that type of transaction. In addition, Web services allow a user to write specific transactions to help reduce the overhead typically found in an interfaced solution.

Thus, certain embodiments eliminate an interface engine communicating between a kiosk and a healthcare information system. Rather, web services are used to communicate between the kiosk 110 and the healthcare information system 120. Portions of the healthcare information system 120 are effectively (i.e., virtually) embedded within the kiosk system 110 (and/or vice versa) and may talk directly to the kiosk system 110 rather than solely through an interface. That is, “calls” or commands are executed for the healthcare information system 120 within the kiosk system 110.

In certain embodiments, a translation layer takes inputs for which the kiosk 110 is looking and converts the inputs from the outputs of the healthcare information system 120. In addition, a translation layer takes the inputs for which the healthcare information system 120 is looking and converts the outputs of the kiosk system 110. Thus, one or more inputs and outputs of the system 120 can be translated to match the inputs and outputs of the kiosk 110 through bi-directional translation. The kiosk system 110 provides an interface to the healthcare information system 120 and allows other web services to call in or access the kiosk interface and communicate with core services for the kiosk 110. Thus, certain embodiments insulate the healthcare information system 120 from third party kiosks and provide interoperability with a variety of kiosk systems 110. In certain embodiments, information system 120 vendors may provide kiosk 110 vendors with a technical specification to which the kiosk 110 vendors should adhere (and/or vice versa).

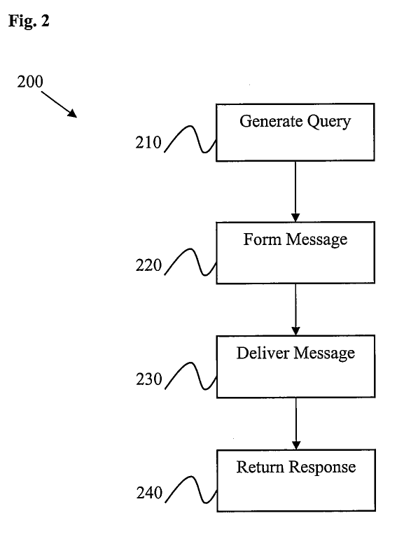

FIG. 2 illustrates a flow diagram for a method 200 for integrating a kiosk with a healthcare information system in accordance with an embodiment of the present invention. At step 210, a query is generated at the kiosk system 110 for the information system 120. At step 220, the query is formed as a message for Web service delivery to the information system 120. For example, the message may be formed as XML content in a SOAP message for communication to the information system 120. At step 230, the message is delivered to the information system 120. At step 240, the information system 120 returns a response to the kiosk system 110 via the Web service. In certain embodiments, the method 200 may be executed from the healthcare information system 120 to the kiosk system 110 substantially as described above.

For example, the kiosk system 110 may query the healthcare information system 120 for a patient based on information provided by the patient at the kiosk 110. The system 120 returns information such as registration, insurance, appointment, visit, workflow and/or financial information that is then used by the kiosk 110 to check in the patient. The kiosk 110 may then return updated registration, insurance, appointment, visit, workflow and/or financial data back to the system 120 for continued processing and/or storage.

One or more of the steps of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments use web services to write specific transactions to help reduce overhead of an interfaced solution. Certain embodiments provide a technical effect of integrated rather than simply interfacing a kiosk system with a clinical information system.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for integrating a kiosk system with a healthcare information system, said method comprising:
generating a query for at least one of information and a service;
forming a message including the query using a Web service;
communicating the message between the kiosk system and the healthcare information system using the Web service; and
returning a result based on the message.

2. The method of claim 1, wherein said step of communicating occurs without an interface engine.

3. The method of claim 1, wherein said Web service comprises a Web service run over a TCP/IP network using the Simple Object Access Protocol.

4. The method of claim 1, wherein said healthcare information system comprises an administrative and financial system.

5. The method of claim 1, wherein said Web service provides said kiosk system with an ability to query said healthcare information system for a list of patients based on search criteria provided at said kiosk.

6. The method of claim 5, wherein said healthcare information system returns information including at least one of registration, insurance, appointment, visit and financial information to said kiosk.

7. The method of claim 6, wherein said information is used by said kiosk to check in a patient.

8. The method of claim 5, wherein said kiosk returns updated at least one of registration, insurance, appointment, visit and financial data back to said healthcare information system.

9. The method of claim 1, wherein said kiosk directly accesses functionality at said healthcare information system.

10. An integrated kiosk and healthcare information system, said system comprising:
a kiosk configured to provide at least one of information and services and configured to accept entry of patient information;
a healthcare information system including patient information, practice information and services; and
a Web service configured to facilitate communication of data between said kiosk and said healthcare information system via a network, wherein data is communicated between said kiosk and said healthcare information system on said network based on a direct query.

11. The systems of claim 10, wherein said kiosk and said healthcare information system are integrated without an interface engine.

12. The system of claim 10, wherein said Web service comprises a Web service run over a TCP/IP network using the Simple Object Access Protocol.

13. The system of claim 10, wherein said healthcare information system comprises an administrative and financial system.

14. The system of claim 10, wherein said Web service provides said kiosk system with an ability to query said healthcare information system for a list of patients based on search criteria provided at said kiosk.

15. The system of claim 5, wherein said healthcare information system returns information including at least one of registration, insurance, appointment, visit and financial information to said kiosk.

16. The system of claim 6, wherein said information is used by said kiosk to check in a patient.

17. The system of claim 5, wherein said kiosk returns updated at least one of registration, insurance, appointment, visit and financial data back to said healthcare information system.

18. The system of claim 10, wherein said kiosk directly accesses functionality at said healthcare information system.

19. An integration system for integrating interaction between a kiosk and a healthcare information system, said integration system comprising:
a Web service configured to facilitate communication of data and commands between a kiosk and a healthcare information system via a network, wherein data and commands communicated between said kiosk and said healthcare information system on said network based on a direct-access query; and
a translation layer configured to convert an output of said healthcare information system to an input for said kiosk and convert an output of said kiosk to an input for said healthcare information system.

20. The system of claim 19, wherein said kiosk and said healthcare information system are loosely coupled yet integrated via said Web service and said translation layer such that changes may be made to at least one of said kiosk and to said healthcare information system without affecting interaction between said kiosk and said healthcare information system.
